(19) United States
(12) Patent Application Publication
(10) Pub. No.: US 2020/0223732 A1
(43) Pub. Date: Jul. 16, 2020

(54) Method and Apparatus for Disintegrating Organic Substrates

(71) Applicant: Andreas Dünnebeil, Teltow (DE)

(72) Inventor: Andreas Dünnebeil, Teltow (DE)

(21) Appl. No.: 16/736,803

(22) Filed: Jan. 7, 2020

(30) Foreign Application Priority Data
Jan. 14, 2019 (DE) 10 2019 200 360.5

(51) Int. Cl. C02F 11/18; C02F 1/66

(52) U.S. Cl. CPC C02F 11/185; C02F 1/66; C02F 2303/26; C02F 2303/06; C02F 2303/04

(57) ABSTRACT

In a method for disintegrating organic substrates, an alkaline solution is added as pH-altering solution to the substrate and said substrate is then treated with steam, or steam is added, for heating to a temperature below 100° C. Under pressureless conditions, the heated substrate admixed with alkaline solution is subjected to a residence time. Preferably, the organic substrates are sludges from wastewater treatment plants.

This United States utility patent application claims priority on and the benefit of German (DE) patent application number 10 2019 200 360.5, filed Jan. 14, 2019, the entire contents of which are hereby incorporated herein by reference.

### DESCRIPTION

### Application Area and Prior Art

The present invention relates to a method for disintegrating organic substrates, especially organic sludges from wastewater treatment, but also substrates for biogas plants, and to an apparatus for carrying out said method.

When wastewaters are cleaned, sewage sludges are obtained by means of sedimentation or thickening as a mixture of organic and inorganic solids and liquid substances. Said sewage sludges are generally subjected to a sludge digestion, the result being that the sewage sludges are stabilized and the dry sludge matter is reduced. To support the anaerobic processes in the digestion, a specific pre-treatment of the sewage sludges is helpful. In this connection, thermal disintegration methods are known, the aim being in particular to disrupt the microorganisms present in the sewage sludges in order to make them better accessible to a further degradation.

Various methods for disintegrating sludges are used on wastewater treatment plants. Various objectives are pursued in this connection. In particular, the resulting quantity of sludge is to be reduced and gas production in the digestion is to be increased, valuable substances are to be recovered and, additionally, polymers in the dewatering are to be saved. What is common on the market are mainly mechanical methods, often based on ultrasound, high-temperature methods above 100° C. and thermal/chemical disintegration methods.

US 2015/0367308 A1 discloses a method in which organic material is thermally pretreated at high pressure. In a preheating step, the organic material is heated with steam in a preheating tank. The heated material is transferred to a downstream hydrolysis reactor. By means of a further supply of steam to the hydrolysis reactor, the pressure is increased up to a desired hydrolysis pressure, for example between 3 and 16 bar, and held for a certain time. Thereafter, the pressurized material is transferred to a downstream pressure reduction tank. Other methods function with heat exchangers. For instance, US 2012/0061318 A1 describes an apparatus for the thermal hydrolysis of organic matter comprising a heating element and a cooling element as heat exchangers, in which heat is exchanged between the organic matter and a medium separated from the organic matter.

Such plants can have considerable disadvantages. In particular, the plant technology is technically complicated owing to the necessary positive pressure of, in some cases, up to 10 bar or more and requires high maintenance. The pressure vessel means that regular technical monitoring is necessary. The high temperatures of, for example, 130° C. to 180° C. mean that the risk of incrustation is relatively high. At the high temperatures, the constituents of the sludge substrates are decomposed as far as possible and, in some cases, converted into new substances. A further disadvantage is the comparatively high energy expenditure. There are attempts to recover a portion of the energy for the inflow via so-called flash tanks. However, under atmospheric conditions, this is possible only for the temperature range above 100° C. Furthermore, a complicated recooling of the sewage sludges heated to high temperatures is generally necessary before the digestion.

Furthermore, what is a major problem for such plants is the, in some cases, very high COD back-pollution (COD—chemical oxygen demand) for the wastewater treatment plant from the centrates, i.e. from the sludge water obtained when dewatering sludge. The COD is normally degraded as far as possible in the activated-sludge process of the wastewater treatment plant by the microorganisms present there. However, at the high temperatures in said plants, what also arises is an often very high proportion of inert COD that is not degraded in the activated-sludge process, but can instead ultimately even get into the outflow of the wastewater treatment plant. The additional energy demand due to the relatively high ventilation rate is likewise disadvantageous.

DE 103 47 476 A1 describes a method and an apparatus for cell disruption in sludges, wherein a small quantity of an alkaline solution is added to the sludge and the resultant sludge mixture is treated in a reactor at a temperature below the boiling point of water in a pressureless manner. This thermal/chemical disintegration requires a heat exchanger for the heating of the substrates. This is disadvantageous, since the heat exchanger requires an occasional cleaning. Furthermore, disproportionately large heat-exchanger surfaces are necessary specifically for relatively large plants and for substrates with comparatively high proportions of solids owing to the high viscosity.

### Object and Solution

It is an object of the invention to provide a method as stated at the start and an apparatus as stated at the start, by means of which it is possible to solve problems of the prior art and it is possible in particular to achieve a thermal/chemical disintegration of organic substrates, especially of organic sludges in wastewater treatment plants, in order to avoid the disadvantages outlined.

This object is achieved by a method having the features of Claim 1 and by an apparatus having the features of Claim 21. Advantageous and preferred configurations of the invention are subject matter of the further claims and are more particularly elucidated below. In this connection, some of the features are described only for the method or only for the apparatus. However, irrespective thereof, they are intended to be able to apply separately and independently of one another both to the method and to the apparatus. The wording of the claims is incorporated in the description by express reference.

The core of the invention is a method for disintegrating organic substrates, wherein the substrate is treated with steam for heating to a temperature below 100° C. or is brought to such a temperature by means of the steam. The heated substrate is subjected to a residence time under pressureless conditions. The organic substrates are in particular organic sludges from wastewater treatment plants (sewage plants). In principle, it is, however, also possible to subject other substrates to said method, for example residual products from agriculture or wastes from industrial food production which are, for example, intended to be utilized as substrates in biogas plants.

The term “disintegration” is understood here to mean the disruption of particulate constituents in organic substrates, especially the disruption of microorganisms or generally the disruption of cellular constituents such as, for example, bacteria, fungi or protozoa. The term “hydrolysis” is frequently also used for this process. The term “organic substrate” or “substrate” encompasses substrates which contain or may contain organic constituents and especially microorganisms. The term “organic sludges” or “sludges” is understood to mean sludges containing organic constituents, i.e. a suspension which can be more or less thickened and which also contains organic constituents at least in part, such as, for example, microorganisms. In particular, the organic sludges encompass sewage sludges which are obtained during wastewater treatment in wastewater treatment plants. The term “residence time” is to be understood to mean the time span within which the steam-heated substrate is incubated so to speak, so that the processes leading to a disintegration of the particulate constituents can take place.

Under the conditions of the proposed method, a thermal/chemical disintegration of the substrate takes place, involving especially the disruption of the microorganisms present in the substrate, with the result that subsequent processes in the further treatment of the substrate, especially in a digestion, can proceed in an improved manner. Particularly advantageously, said method can be used for a disintegration of excess sludge from wastewater treatment plants or sewage plants. A substantial difference in relation to previous methods with the same objective is the use of a steam treatment, especially in the form of steam admixing or steam injections, in pressureless plants having a process temperature below 100° C., for example between 40° C. and 95° C. This avoids complicated and high-maintenance heat exchangers and it is also possible to directly process highly viscous substrates with distinctly higher solids contents than in the case of conventional methods. A flash evaporation after the process is not necessary because of the temperature below 100° C.

Advantageously, a pH-altering solution, advantageously an alkaline solution, is added to the substrate. Alternatively, it can be an acid. Both will be more particularly elucidated below. The residence time is then the time during which the substrate heated by means of steam and admixed with the pH-altering solution is incubated.

The sludge is preferably a sludge having a solids content between 2% and 20%, especially between 4% and 16%, preferably between 6% and 12%. For example, the sludge is an excess sludge from a wastewater treatment plant, especially a thickened excess sludge. An excess sludge is to be understood here to mean generally a sludge which is obtained in the secondary clarification in a biological treatment step in wastewater treatment plants and is removed from the system as excess biomass. A sludge with such a solids content is a highly viscous substrate. The particular advantage of the proposed method is that such highly viscous substrates can also be treated. This is possible especially through the intended steam treatment. Thus, one particular advantage of the proposed method is also that the sludges can be thickened further than, for example, in the case of conventional plants which operate with heat exchangers. Therefore, volume can be saved in subsequent method steps, for example in the digestion.

The pH-altering solution is, in the case of an alkaline solution, preferably sodium hydroxide solution, especially 50% sodium hydroxide solution. Sodium hydroxide solution is particularly preferred because it is highly cost-effective and has been found to be highly effective in experiments relating to the invention. In preferred configurations of the proposed method, 1 to 5 litres of sodium hydroxide solution per m³ of substrate, especially 1.5 litres of sodium hydroxide solution per m³ of substrate, can be added. Thus, comparatively small quantities of sodium hydroxide solution are concerned. The addition of the alkaline solution alters and especially increases the pH of the substrate. Advantageously, the pH of the substrate directly after the addition of the alkaline solution is approximately within a range between pH 8-12. Particular preference is given to a range between pH 10-11. In the course of the residence time, i.e. during the thermal/chemical disintegration of the substrate that takes place, the pH of the substrate is largely neutralized. For the addition of the sodium hydroxide solution or, generally, of the alkaline solution, it is possible to use metering units known per se, with the alkaline solution being metered preferably before the steam treatment, or the steam admixing or steam injection. In principle, the alkaline solution can, however, also be metered during or after the steam treatment, or steam admixing or steam injection.

Alternatively, an acid can also be added as pH-altering solution, the result being that the pH is accordingly lowered. In this connection, a pH of pH 2-6, advantageously between pH 3-4, can be set. It can, for example, be nitric acid or sulfuric acid. This might be advantageous for subsequent steps in which a recovery of phosphorus may be concerned. In this connection, although there is then a strong drop in pH, there is, however, at the same time also an increase in the proportion of dissolved phosphate as a result.

For the heating or treatment with steam, steam is appropriately preferably used as saturated steam. Advantageously, low-pressure saturated steam can be used. Steam generation, for which fresh feed water is usually used, can, for example, take place in boilers. Furthermore, it is possible that at least a portion of the necessary steam is generated in the flue-gas waste-heat boiler of a combined heat and power plant usually present and is used for the proposed method. The treatment of the substrate with the steam is appropriately achieved via a steam injection, but a steam admixing, for example with the support of a stirrer or mixer, is also conceivable.

The steam treatment heats the substrate especially to a temperature between 40° C. and 95° C. Particular preference is given to a temperature between 60° C. and 75° C., especially between 65° C. and 75° C., especially between 70° C. and 75° C., preferably 72° C. Advantageously, the intended temperature is held during the intended residence time of the substrate. If necessary, this can be achieved or supported by reheating or by other measures.

The residence time, i.e. the incubation time so to speak for the thermal or the thermal/chemical disintegration, can be about 0.2 h to 3 h, advantageously 0.5 h to 2 h. The appropriate period achieving sufficient disintegration is dependent especially also on the temperature of the heated substrate. The higher the temperature, the shorter the residence time can be. For example, a residence time of 0.5 h to 1 h may be sufficient at a temperature between 70° C. to 75° C., whereas a residence time of 1.5 h to 2 h can be provided at a temperature of 65° C. In a particularly preferred configuration of the proposed method, the legal requirements that may exist for a hygienization of the substrates are fulfilled by said method, a hygienization prescribed by law generally stipulating a heat treatment at at least 70° C. for 1 h or for 30 min.

This incubation is appropriately carried out in one or more residence vessels intended therefor. Preferably, a mixing of the substrate is provided during the residence time. For this purpose, flow guides or stirrers can be provided in the residence vessel(s). A mixing operation ensures a uniform adjustment of temperature within the substrate during the incubation and avoids pockets of coldness. This applies to an implementation as hygienization in a so-called batch process. In the case of a classic method in which hygienization is not carried out, preference is given to a type of plug flow so that all parts of the sludge have a uniformly high residence time. For such a plug flow, cascading can be implemented.

To carry out the disintegration, the substrate which has advantageously been admixed with the alkaline solution, which has optionally already been heated by a steam treatment, is transferred to the residence vessel(s), where the incubation to allow the disintegration process to proceed is carried out for the intended residence time. In this connection, the steam treatment can already take place in the inflow of the plant, for example by means of a steam injection, with the result that the substrate to be treated reaches the residence vessel in a preheated state. As an alternative or in addition, what can be provided is that the steam treatment, for example the steam injection, takes place in the residence vessel. Furthermore, it is possible that the steam treatment is carried out in the course of a circulation of the substrate between the residence vessel and an upstream steam treatment point, for example opening of a steam injection unit, this generally requiring a suitable circulation pump. If, for example, multiple residence vessels are connected in series, such a circulation can, for example, be provided only for the first residence vessel of said series. The heating of the substrate can, furthermore, be achieved by a combination of these various possibilities.

The proposed method can be carried out in batch mode. Performance in a batch mode has the particular advantage that this involves being able to realize the conditions for a hygienization of the substrate, especially at least 70° C. for 1 h, under suitable process control in a verifiable manner.

Preferably, the substrate in the case of a hygienization is transferred to two or more residence vessels, preferably to three residence vessels, for the residence time, it being possible for the two or more residence vessels to be alternately charged with the substrate. Particular preference is given to a configuration with three residence vessels which can be alternately charged. In this case, within one cycle a first residence vessel is filled and optionally heated, in a second residence vessel the temperature for disintegration/hygienization is held for the period of the residence time, and in a third residence vessel the treated substrate is discharged. As a result, it is possible to realize a virtually continuous process control, in which a hygienization that may be prescribed by law can also be achieved. The substrate which has advantageously been admixed with the pH-altering solution is, then, alternately distributed over multiple residence vessels. What has been found to be effective here are three-vessel systems having a minimum cycle time, as required for hygienization. Typical parameters are cycle times of at least 60 minutes at temperatures just above 70° C., for example 75° C. What is advantageous are temperatures above 70° C. for 30 minutes; the stated 60 minutes are more usual only in the EU and countries which have adopted EU regulations.

In a preferred configuration of the proposed method, a preheating of the substrate by the return flow of an already heated substrate volume is carried out before the treatment of the substrate with steam. Thus, the inflowing substrate can be at least partially preheated by the outflowing substrate. As a result, a corresponding plant can be operated particularly efficiently and the quantity of the required steam can be reduced.

To hold the temperature of the heated substrate as constant as possible during the residence time, a reheating of the substrate can be provided during the residence time. If, for example, a steam injection directly into the residence vessel is provided, a repeated steam injection can be performed. If the steam treatment or a steam injection is upstream of the residence vessel, a circulation of already heated substrate from the residence vessel back to a steam injection point can be provided.

The treated substrate can be subjected to a digestion after the residence time. The combination of the proposed method with a digestion has the particular advantage that the proposed method achieves a preparation (hydrolysis) of the substrates, which facilitate and improve subsequent processes in a digestion.

In preferred configurations of the proposed method, an at least partial cooling of the treated substrate can be provided after the residence time. Thus, the outflowing substrate can be at least partially cooled. A cooling operation can, for example, be achieved with the aid of a cooling medium, and the cooling medium heated in this connection can be used for heating other processes. Furthermore, a cooling operation can, for example, be achieved using a wastewater treatment plant outflow. In particular, a cooling operation may be appropriate if what is subsequently provided is, for example, a mesophilic digestion of the substrate, where the temperature of the substrate from the incubation for the thermal/chemical disintegration would be too high therefor. In the case of the treatment of sludges in wastewater treatment plants, the substrate or the sludge can, for example, be admixed with cold primary sludge from the mechanical wastewater cleaning step in order to thus achieve a drop in temperature.

It is also possible to include in the proposed method further supplementary substrates which, as part of the overall process, are likewise to be utilized and/or are to be subjected to a hygienization. Supplementary substrates that can be utilized are, for example, various utilizable products from waste management, such as, for example, slaughterhouse wastes, vegetable-based extraction products, food scraps or the like. Depending on the nature of said supplementary substrates, a decision can be made as to whether the supplementary substrates are to be exposed to the temperature conditions of the proposed method with or without addition of the alkaline solution, and so the feeding of the supplementary substrates can be effected at an appropriate point in the plant.

The invention further encompasses an apparatus for carrying out the described method. The apparatus comprises at least one unit for treating the substrate with steam, i.e. for heating. Advantageously, the apparatus also comprises at least one metering unit for a pH-altering solution or alkaline solution. Further provided is at least one residence vessel intended for a residence time of the steam-treated substrate which has advantageously been admixed with alkaline solution. Particularly preferably provided are three residence vessels, preferably in the case of an additional hygienization, which are alternately chargeable with substrate. As a result, it is possible to realize a virtually continuous process control. Preferably, at least one steam injection unit or other steam admixing system that opens into an inflow of the residence vessel (or the residence vessels) and/or directly into the at least one residence vessel is provided for the treatment of the substrate with steam. If a steam injection unit with one opening point for steam is provided outside the residence vessel(s), at least one pump for a recirculation of substrate from the residence vessel or, in the case of multiple residence vessels, from one or more of the residence vessels to the opening point of the steam injection unit(s) can be provided in order to allow a reheating of the substrate in the residence vessel. With regard to further features of the apparatus, reference is made to the above description in relation to the method.

The apparatus can especially be a plant for the subsequent digestion of sludges from wastewater treatment. Such a plant can, for example, be operated in a pressureless manner at a temperature of approx. 60° C. to 70° C. Compared to high-temperature plants, the lower temperature level generates lower proportions of inert COD quantities. To achieve similar effects as in the case of the high-temperature methods, with regard to additional gas production and reduction in the quantity of solids, the addition of low quantities of alkaline solution has been found to be effective in experiments. The proposed plant can be used especially for the processing of excess sludge of a wastewater treatment plant. After the disintegration of the sludge which has been admixed with alkaline solution and heated, the warm substrate can, after the residence time, be cooled with the remaining, cold primary sludge to the ideal temperature for the subsequent digestion. In other configurations, the primary sludge can also be subjected to the disintegration according to the proposed method.

These and further features are apparent not only from the claims but also from the description and the drawings, wherein the individual features can in each case be realized on their own or jointly in the form of sub-combinations in an embodiment of the invention and in other fields and can constitute advantageous and inherently protectable embodiments for which protection is claimed here. The subdivision of the application into individual sections and subheadings does not restrict the statements made thereunder in terms of their general validity.

### BRIEF DESCRIPTION OF THE DRAWINGS

Further features and advantages of the invention are revealed by the following description of exemplary embodiments in conjunction with the drawings. Here, the individual features can in each case be realized separately or in combination with one another. In the drawings:

FIG. 1 shows a block diagram to illustrate a first embodiment of the proposed method;

FIG. 2 shows a block diagram to illustrate a further embodiment of the proposed method;

FIG. 3 shows a block diagram to illustrate a further embodiment of the proposed method;

FIG. 4 shows a schematic representation of a plant for carrying out a first embodiment of the proposed method; and

FIG. 5 shows a schematic representation of a plant for carrying out a further embodiment of the proposed method.

### DESCRIPTION OF THE EXEMPLARY EMBODIMENTS

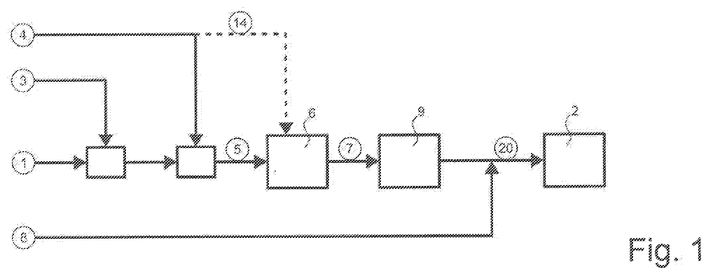

FIG. 1 shows a block diagram to illustrate an exemplary configuration of the proposed method. The method is used for the disintegration of thickened excess sludge 1 in this example, and the excess sludge 1 can, for example, be thickened to a solids content of 4% to 8% or up to 16% in order to save an appropriate volume in the subsequent digestion 2. The thickened excess sludge 1 is admixed here with an alkaline solution 3 as pH-altering solution, preferably 50% sodium hydroxide solution. Depending on the proportion of organic material in the excess sludge, a quantity of 1 to 5 litres per m³ of sludge, usually approx. 1.5 litres per m³, is necessary for this purpose. This depends on the desired degree of disruption, and is appropriately explicitly ascertained for the particular sludge. What is customary is a degree of disruption of approx. 40-50% based on the chemical oxygen demand. Although the addition of the alkaline solution or a pH-altering solution in general is advantageous, it is not imperative. Even in the absence of a pH-altering solution, solely the increase in temperature brings about a disintegration, albeit admittedly only to a lesser extent.

Subsequently, the sludge is heated with saturated steam 4 to a temperature of about 65° C. in a virtually pressureless manner. Preference is given to using saturated steam because it is better than superheated steam at condensing in the substrate or sludge and thereby releasing its heat. If, for example, there is an excess sludge thickened to 15% solids and having a volume flow of 10 m³/h at a temperature of 15° C., this requires a quantity of steam of approx. 0.9 to. The solids concentration is reduced to approx. 13.8% by the introduced quantity of water. Subsequently, the heated sludge 5 admixed with sodium hydroxide solution is subject to a residence time of 1.5 to 2 hours in a residence vessel 6. As an alternative or in addition to an introduction of the steam 4 upstream of the residence vessel 6, i.e. in the inflow, what can also be provided is that steam 14 is introduced directly into the residence vessel 6. The residence vessel 6 is preferably designed such that low mixing, but not short-circuit flows, can occur. In this way, what is achieved is that all the particles of the sludge 5 pass through the residence time effectively. To achieve this objective, the residence vessel 6 can, for example, be provided with flow-guiding fixtures. After the residence time within the residence vessel 6, the disintegrated, warm excess sludge 7 is mixed with cold primary sludge 8 or some other nontreated substrate. Optionally, what can be provided beforehand is a further cooling operation 9, which is, however, generally not absolutely necessary. The mixture 20 of cold primary sludge and disintegrated excess sludge usually has a temperature below or at the temperature of the digestion space, meaning that the entire thermal energy which is fed into the system via the steam 3 can be used in the digestion 2.

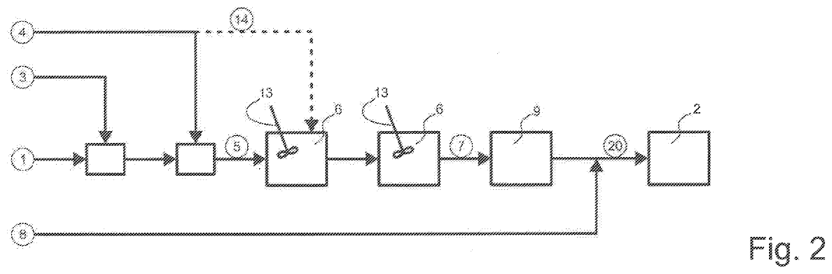

FIG. 2 illustrates a further possibility for carrying out the proposed method, the method shown being comparable with the method shown in FIG. 1 in large parts and being provided with the same reference signs. In contrast to the method as per FIG. 1, what is provided for the method as per FIG. 2 are two (or more) residence vessels 6, which are connected successively as a cascade. As a result, short-circuit flows can be minimized effectively. Especially in the case of high or very high solids concentrations, it may additionally be advantageous to provide the residence vessels 6 with stirrers 13 in order to prevent deposition.

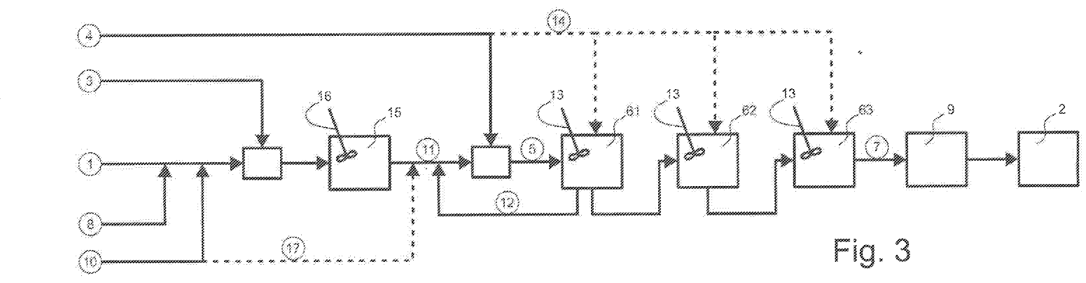

To achieve or to be able to demonstrate compliance with legal requirements concerning a hygienization (Regulation (EC) No 1069/2009 of the European Parliament and of the Council of 21 Oct. 2009; EPA/625/R-92/013, December 1992), a batch process with a minimum temperature over the entire holding time (residence time) in a closed area is necessary. The legal requirements stipulate that a temperature of at least 70° C. must be observed over the residence time for this purpose, for at least 60 minutes according to (EC) No 1069/2009 and for least 30 minutes according to EPA/625/R-92/013. Both requirements can be readily integrated in the proposed method, especially in a configuration of the method in which primary sludge 8 is added as well to the disintegration. The conditions used for the disintegration of the organic substrate according to the proposed method simultaneously fulfil, then, the conditions for a hygienization, in which any pathogens present in the substrate are inactivated. Such a configuration of the method is illustrated in FIG. 3. In said configuration of the method, all the substrates ultimately reaching the digestion 2 are disintegrated according to the proposed method and hygienized at the same time, and so legal requirements that may exist concerning hygienization for the substrates are met. In said configuration, both the primary sludge 8 and the excess sludge 1 are treated together. Similarly as described above, the substrate mixture composed of excess sludge 1, primary sludge 8 and optionally supplementary substrates 10 is admixed with alkaline solution as pH-altering solution (e.g. 50% sodium hydroxide solution) as alkaline solution 3, i.e. approx. 1 to 5 litres per m³ of substrate. As an alternative to alkaline solution, an acid can also be added, as described above. A separate intermediate vessel 15 with stirrer 16 can be provided for the mixing and action of the sodium hydroxide solution 3. The substrate mixture 11 admixed with sodium hydroxide solution 3 is then heated with steam 4 such that the hygienization temperature is held for the required time of at least 60 or 30 minutes. Usually, the temperature is a little, for example approx. 2 K, above the hygienization temperature in order to compensate for the heat losses during the hygienization time (residence time), i.e. the substrates are heated to 72° C. If further supplementary substrates 10, which must likewise be hygienized according to the legal provisions, should be conveyed into the digestion 2, they should also be co-heated. The nature of the supplementary substrates determines whether an admixing with sodium hydroxide solution 3 appears appropriate. For example, if there are no proportions of cells in the supplementary substrates 10, a disruption may not be appropriate or necessary. If this is the case, the substrates 1 and 8 already admixed with sodium hydroxide solution 3 should remain in contact with the sodium hydroxide solution 3 for a certain time alone without the supplementary substrates. A residence time of 10 to 20 minutes is generally sufficient to this end. This can take place in the intermediate vessel 15, which is equipped here with a stirrer 16, but this is not imperative.

The supplementary substrates not to be admixed with sodium hydroxide solution are conducted past the intermediate vessel 15 with the line 17, and are then heated together with the already pretreated substrates 1 and 8. The now warm substrate mixture 5 admixed with sodium hydroxide solution 3 reaches the first residence vessel 61. Altogether, three residence vessels 61, 62, 63 of identical construction, each having a stirrer 13, are provided. The development of “cold pockets” is avoided by means of the stirrers 13. The three residence vessels 61, 62, 63 are advantageously alternately charged and each change the tasks, alternatively as a cascade as depicted more here. A piping system for an alternate charging is, however, easily imaginable. In the first cycle, residence vessel 61 is charged. On residence vessel 62, which has already been charged, all inflows and outflows have been closed. The substrate mixture 5 resides in the residence vessel 62 at least for the required residence time. The residence vessel 63 is emptied in said cycle. When the residence time required for the hygienization in the residence vessel 62 has at least lapsed, the tasks of the individual residence vessels change. Residence vessel 61 has now been filled, all inflows and outflows have been closed and the substrate mixture 5 remains at least for the residence time required for the hygienization. The hygienized substrate mixture 5 situated in the residence vessel 62 is discharged for further treatment. The residence vessel 63 is empty at the start of this cycle and is now filled within this cycle with heated substrate mixture 5 admixed with alkaline solution. When the required hygienization time has lapsed, said cycle is completed. In the next cycle, residence vessel 62 is filled, the residence vessel 63 resides in the closed state over the residence time and residence vessel 61 is emptied within this time. After the residence time required for the hygienization in the residence vessel 63 has lapsed, the 3-part cycle can be started over again.

If, after the filling of a residence vessel 61, 62 or 63, the temperature required for the hygienization and/or disintegration should not be reached or not be held, the respective residence vessel can be reheated via a circulation 12, shown here by way of example for residence vessel 61. It is also possible to heat the residence vessels 61, 62, 63 directly by means of a steam injection 14, shown with a dashed line, or other above-mentioned admixing of steam, it then being necessary for the residence vessels 61, 62, 63 to be equipped with such a means of heating.

In this method variant, after the hygienization and disintegration, the outflow temperature for the charging of the usually mesophilic digestion is too high at about over 70° C. Therefore, a cooling operation 9 is appropriate in this case. A cooling operation is generally not necessary if a thermophilic digestion at this temperature level is intended. A cooling operation can, for example, also be achieved by means of a substrate or by means of the entirety of the supplied substrates, which are thereby preheated to a certain extent.

It is likewise possible that the process for disintegration and hygienization by means of pH-altering solution, especially alkaline solution, and steam admixing or steam injection also takes place in one or alternatingly two residence vessels.

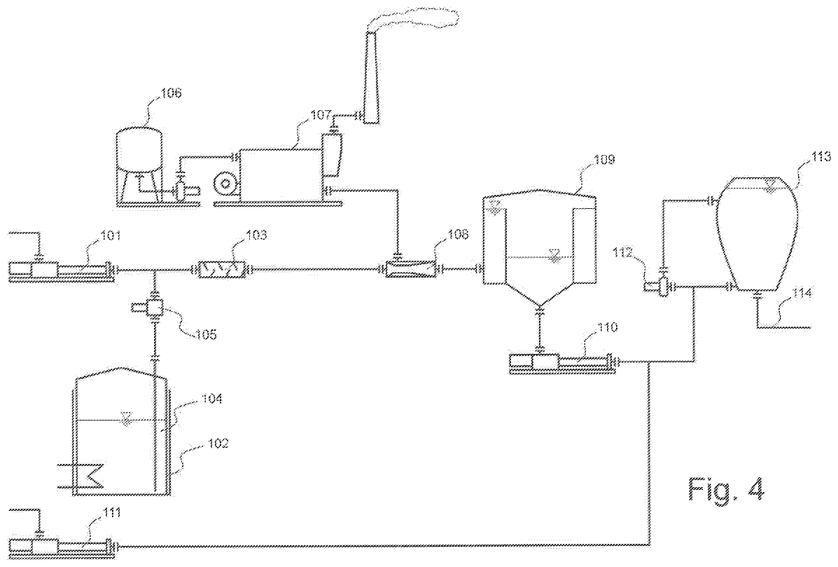

FIG. 4 shows schematically a plant for the pre-treatment of sludges according to the proposed method, the sludges being intended for a digestion. The thickened excess sludge is fed into the system by means of the pump 101 and admixed in the region of a metering point 103 with sodium hydroxide solution as alkaline pH-altering solution 102, there being provided for this purpose a storage vessel 104 for the sodium hydroxide solution 102 and a metering unit 105, for example a metering pump or a metering valve. Treated feed water from a water tank 106 is converted into low-pressure saturated steam in a steam generator 107 and injected at the steam injection point 108 into the sludge admixed with sodium hydroxide solution. The sludge is conducted further into the residence vessel 109, the incubation for the disintegration of the organic sludge taking place in the residence vessel 109. After the intended residence time has lapsed, the sludge is removed from the residence vessel 109 by means of the pump 110. In a subsequent pipeline section, cold primary sludge is fed in by means of a further pump 111 and mixes with the treated excess sludge from the residence vessel 109, resulting in the sludge being cooled down to a temperature suitable for a subsequent digestion. By means of the pump 112, the sludge is pumped further to the digestion in the digestion vessel 113. The pump 112 is advantageously a circulation pump near the digestion for mixing it. The treated sludge can be concomitantly fed into this circulation, because specifically a mixing operation in the somewhat more turbulent flow and in the circulation pump is thus achieved. The digested sludge leaves the digestion vessel 113 via the outlet 114 and is conveyed to the next method steps, such as, for example, dewatering or phosphorus recovery. In this system, the entire sludge line remains pressureless. Only the steam region has a slightly positive pressure, so that the steam can be injected.

As an alternative or in addition to the steam generator 107, the steam generation can be realized by means of a waste-heat boiler of a combined heat and power plant. Furthermore, it is possible that the steam is introduced directly into the residence vessel 109 as an alternative or in addition to the introduction in the inflow.

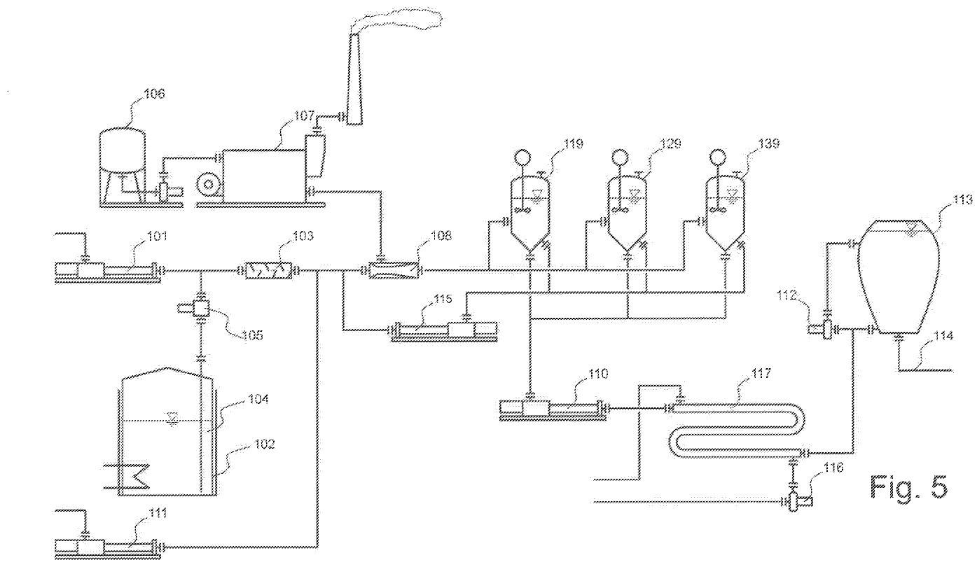

FIG. 5 shows schematically a further plant for the pre-treatment of sludges according to the proposed method, the sludges being intended for a digestion. In large parts, said plant corresponds to the plant illustrated in FIG. 4. The corresponding elements are provided with the same reference signs. Both the excess sludge and primary sludge are subjected to a treatment according to the proposed method in said plant, in contrast to the plant from FIG. 4, with the result that the legal requirements concerning a hygienization can be realized for all substrates which are subjected to the subsequent digestion. The primary sludge is, then, mixed into the system downstream of the metering point 103 for the sodium hydroxide solution by means of the pump 111, with the result that the primary sludge together with the excess sludge is heated to the required temperature by means of the steam injection at the steam injection point 108. To also fulfil the legal provisions, the plant is operated in batch mode, with, in contrast to the plant from FIG. 4, use of three residence vessels 119, 129, 139 which are alternately charged. The volume of the residence vessels 119, 129, 139 is determined by the required length of the residence time, wherein the length of the residence time can depend on the required extent of disintegration of the particulate components of the sludge and/or on the legal hygienization requirements. Furthermore, a circulation pump 115 is provided, by means of which the sludge can be removed from the residence vessels 119, 129, 139 and fed once more into the region of the steam injection point 108. This measure makes a reheating of the sludge in the residence vessels 119, 129, 139 possible, for example in respect of the observance of the hygienization provisions. As an alternative or in addition, a steam injection in the residence vessels 119, 129, 139 can be provided, which is not shown here. After the residence time in the respective residence vessels 119, 129, 139 has lapsed, the treated sludge is removed from the residence vessels 119, 129, 139 by means of the pump 110 and conveyed further into the digestion vessel 113 by means of the pump 112. Since the digestion in the digestion vessel 113 is often operated as a mesophilic digestion at approx. 40° C., a cooling 117 of the treated sludge is necessary. What is used as cooling medium in this plant is the wastewater treatment plant outflow, which is conveyed via the pump 116.

A comparative calculation shows the differing energy expenditure between the system of a thermal/chemical treatment with steam heating as per the method according to the invention, as illustrated in FIG. 5, and a conventional thermal pressure treatment, on the basis of an example of 10 m³/h and a sludge concentration of 15% DM (DM is dry matter) in the input. A summarization of a comparative calculation comes to the following result, even with assumption of the complete recovery of energy via a flash evaporation in the case of the thermal pressure treatment:

| | | Thermal/chemical | Thermal | | |
|---|---|---|---|---|---|
| Material | | treatment with | pressure | | |
| stream | Unit | steam | treatment | Comparison | |
| Quantity of | kg/h | 921 | 1677 | −756 | kg/h |
| steam | | | | | |
| Steam | kW | 630 | 1147 | −517 | kW |
| energy | | | | | |
| Quantity of | 1/h | 15 | 0 | +15 | 1/h |
| sodium | | | | | |
| hydroxide | | | | | |
| solution | | | | | |
| Additional | m³/h | 0 | 39.7 | −39.7 | m³/h |
| cooling | | | | | |
| water | | | | | |
| demand | | | | | |
| Additional | kW | 0 | 459 | −459 | kW |
| cooling | | | | | |
| energy | | | | | |

Overall, the proposed method is thus substantially more favourable compared to a thermal pressure treatment with respect to the required quantity of steam and the steam energy and with respect to the cooling water demand and the cooling energy. Furthermore, the proposed method can be realized as a pressureless system with low maintenance using simple components typical of a wastewater treatment plant and furthermore offers in general the advantages of a thermal/chemical treatment, especially a high increase in total gas production, a resultant, distinct reduction in the quantity of solids to be disposed of, a higher solids content in the dewatering, a saving of required polymers and a reduction in the required digestion time, with the processing of highly viscous substrates, i.e. even of sludges having a relatively high solids concentration, being possible at the same time as a result of the heating by means of steam treatment.

I claim:

1. Method for disintegrating an organic substrate, wherein said substrate is treated with steam for heating said substrate to a temperature below 100° C., and wherein said substrate is subjected to rest for a residence time under pressureless conditions.

2. Method according to claim 1, wherein a pH-altering solution is added to said substrate.

3. Method according to claim 1, wherein said organic substrate is sludge from wastewater treatment plants or is a substrate which is introduced into a biogas plant.

4. Method according to claim 3, wherein said sludge has a solids content between 2% and 20%.

5. Method according to claim 2, wherein said pH-altering solution is alkaline.

6. Method according to claim 5, wherein said pH-altering solution is sodium hydroxide solution.

7. Method according to claim 5, wherein 1 litre to 5 litres of sodium hydroxide solution per m³ of substrate are added.

8. Method according to claim 1, wherein said steam is saturated steam.

9. Method according to claim 8, wherein said steam is low-pressure saturated steam.

10. Method according to claim 1, wherein said substrate is heated to a temperature between 40° C. and 95° C.

11. Method according to claim 10, wherein said substrate is heated to a temperature between 70° C. and 75° C.

12. Method according to claim 1, wherein said residence time is between 0.5 h and 3 h.

13. Method according to claim 1, wherein a mixing of said substrate is provided during said residence time.

14. Method according to claim 1, wherein said method is carried out in batch mode.

15. Method according to claim 1, wherein said substrate is situated in at least one residence vessel during said residence time.

16. Method according to claim 15, wherein said substrate is situated in two or more of said residence vessels during said residence time, wherein said residence vessels are alternately charged with said substrate.

17. Method according to claim 1, wherein a preheating of said substrate by a return flow of an already heated substrate volume is provided before a treatment of said substrate with said steam.

18. Method according to claim 1, wherein a reheating of said substrate is provided during said residence time.

19. Method according to claim 1, wherein said substrate is subjected to a digestion after said residence time.

20. Method according to claim 1, wherein an at least partial cooling of said substrate is provided after said residence time.

21. Apparatus for carrying out a method according to claim 1, comprising at least one unit for treating said substrate with said steam and comprising at least one residence vessel intended for said steam-treated substrate to rest in said vessel for said residence time.

22. Apparatus according to claim 21, comprising at least one metering unit for metering a pH-altering solution that has been added to said substrate.

23. Apparatus according to claim 21, wherein said residence vessel is designed for a residence time of said substrate admixed with pH-altering solution and treated with said steam.

24. Apparatus according to claim 21, wherein at least one unit for admixing said steam opening into an inflow of said residence vessel or into said at least one residence vessel is provided for said treatment of said substrate with said steam.

25. Apparatus according to claim 21, wherein at least one pump for a recirculation of said substrate from said residence vessel to said opening point of said unit for admixing steam is provided.
